(19) United States
(12) Patent Application Publication
(10) Pub. No.: US 2005/0254406 A1
(43) Pub. Date: Nov. 17, 2005

(54) Optical recording medium

(76) Inventor: Shinya Yoshida, Kashiba-shi (JP)

Correspondence Address: EDWARDS & ANGELL, LLP, P.O. BOX 55874, BOSTON, MA, 02205, US

(21) Appl. No.: 10/526,594

(22) PCT Filed: Sep. 3, 2003
(86) PCT No.: PCT/JP03/11230

§ 371 Date: Mar. 4, 2005

(30) Foreign Application Priority Data
Sep. 4, 2002 (JP) 2002258825
Aug. 4, 2003 (JP) 2003285675

(51) Int. Cl. G11B 7/26; G11B 7/24

(52) U.S. Cl. 369/275.1; 369/272.1

(57) ABSTRACT

When adding to a conventional medium such a function that allows it to have a value in its design as does a trading card, a design needs to be made while avoiding a through hole of about 10 mm long in diameter provided in the center of the medium, which substantially reduces the degree of freedom and the value of the design. An optical recording medium of the present invention is composed of one substrate, and the substrate has a circular or annular recess formed in one face thereof and a design put on the center of the other face thereof.

### TECHNICAL FIELD

The present invention relates to an optical recording medium having a design put on a face thereof, and more particularly, to an optical recording medium with a business card-size design.

### BACKGROUND ART

Optical recording media have been widely used as large-capacity data-recording media, and particularly, CD-ROMs (Read Only Memories) and DVD-ROMs which are distributed with data recorded thereon have been very widely used because of their cheap manufacturing costs. In FIG. 11 and FIG. 12, a sectional view and a plan view of such an optical recording medium are shown, respectively. An optical recording medium 101 is composed of a circular substrate 102, and it has an outside diameter of 120 mm and a cylindrical through hole 103 provided in the center thereof. A data storage area 105 in one face 104 of the substrate 102 has optical data recorded thereon as microscopic lands and grooves which are referred to as pits, and light is applied to the other face 106 for data readout (see, for example, Japanese Examined Patent Publication No. HEI 8(1996)-10497 (page 3, FIG. 5)).

The face 104 having information recorded thereon is covered with a resin 107 for protection of the recorded data and, for example, song titles, a face of a musician and the like of recorded music data are printed on the resin.

Once the optical recording medium 101 is set on a readout device, the medium 101 is fixed on an unillustrated spindle so that the rotation axis of the unillustrated spindle and the center of the medium are in agreement with each other using the through hole 103. Then, while the spindle rotates the medium 101, light is applied onto the face 106 as described above to read data out.

In addition to the above example of disk-shaped optical recording media, there is also proposed, for example, a card-shaped optical recording medium in which a design is printed on an optical card (see, for example, Japanese Unexamined Patent Publication No. SHO 64(1989)-16696 (page 2, FIG. 1)).

When adding to each of the above-mentioned media such a function that allows it to have a value in its design as does a trading card, the following problem arises. That is, because each medium has a through hole of about 10 mm diameter provided in the center thereof, a design needs to be made while avoiding the through hole, which substantially reduces the degree of freedom and the value of the design.

An area within 40 mm around the though hole serves as a clamping area 108 for fixing the medium onto a spindle in a predetermined horizontal plane and is pressed by a chuck and a fastening clamp. This considerably damages a design, practically preventing a design to be made thereon. Because trading cards and the like are usually collected in large numbers and carried around to satisfy their purpose, they have a size of approximately a business card, that is, about 60 mm×90 mm. However, in the case of conventional optical recording media having in the center thereof an area 40 mm long in diameter on which a design cannot be put, it has been difficult to impart thereto such a function that allows the media to have a value in their design as does a trading card.

The present invention has been made in view of the above problems and an object thereof is to provide an optical recording medium having an added value that allows a design to be put entirely on one face of the medium including the center thereof. In other words, an object of the present invention is to provide an optical recording medium having combined an optical data recording function and a function that allows the medium to have a value in its design as does a trading card.

### DISCLOSURE OF INVENTION

An optical recording medium of the present invention is characterized in that one face of a substrate of the medium has a circular recess formed therein for engagement with a rotating device for the optical recording medium, and the other face of the substrate is flat having no projections and depressions, the flat face having a design put at least approximately on the center thereof.

In the above constitution, the flat face is referred to as “having no projections and depressions” in order to be clearly distinguished from the one face having the recess. The flat face is visually flat, but in microscopic terms, it has a directly printable rough surface.

The circular recess is cylindrically formed approximately on the center of the medium, or is annularly formed with respect to the rotation center of the medium. The annular recess preferably has an arc or triangle cross-section, and each corner between the arc or triangle and the substrate face forms an obtuse angle when seen in cross section.

Further, the optical recording medium of the present invention is characterized in that the substrate is composed of one plastic substrate, and the design put on the other face of the plastic substrate is formed by means of printing. Alternatively, the medium of the present invention may be constructed such that the substrate is composed of one plastic substrate, and the other face of the medium has optical data recorded thereon and is provided with an adhesive layer and a cover layer attached by the adhesive layer, the design being put on a surface of the cover layer.

The medium of the present invention preferably includes a metal piece or a magnetic element integrated in the substrate. The medium preferably includes a memory, particularly, a semiconductor memory integrated in the substrate, and preferably, further includes an antenna which is connected to the memory integrated in the substrate.

### BRIEF DESCRIPTION OF DRAWINGS

FIG. 1 is a sectional view of an optical recording medium according to a first embodiment of the present invention;

FIG. 2 is a plan view of the optical recording medium according to the first embodiment of the present invention;

FIG. 3 is a plan view of the optical recording medium according to the first embodiment of the present invention;

FIG. 4 is a sectional view of an optical recording medium according to a second embodiment of the present invention;

FIG. 5 is a view illustrating a sectional shape of an annular recess;

FIG. 6 is a view illustrating a sectional shape of another annular recess;

FIG. 7 is a sectional view of an optical recording medium according to a third embodiment of the present invention;

FIG. 8 is a sectional view of an optical recording medium according to a fourth embodiment of the present invention;

FIG. 9 is a sectional view of an optical recording medium according to a fifth embodiment of the present invention;

FIG. 10 is a plan view of the optical recording medium according to the fifth embodiment of the present invention;

FIG. 11 is a sectional view of a conventional optical recording medium; and

FIG. 12 is a plan view of the conventional optical recording medium.

### BEST MODE FOR CARRYING OUT THE INVENTION

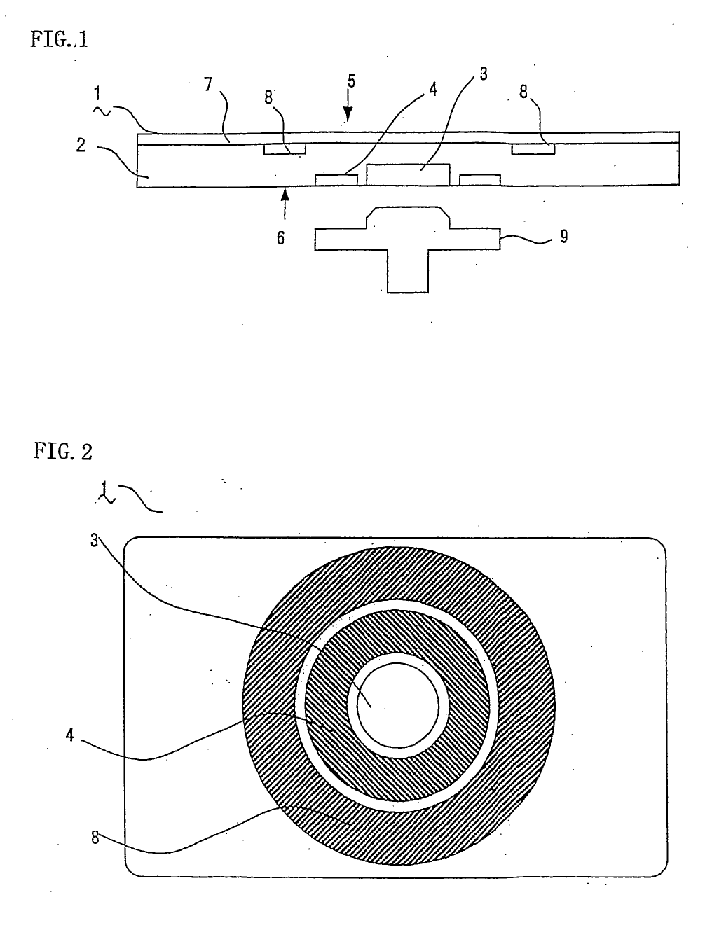

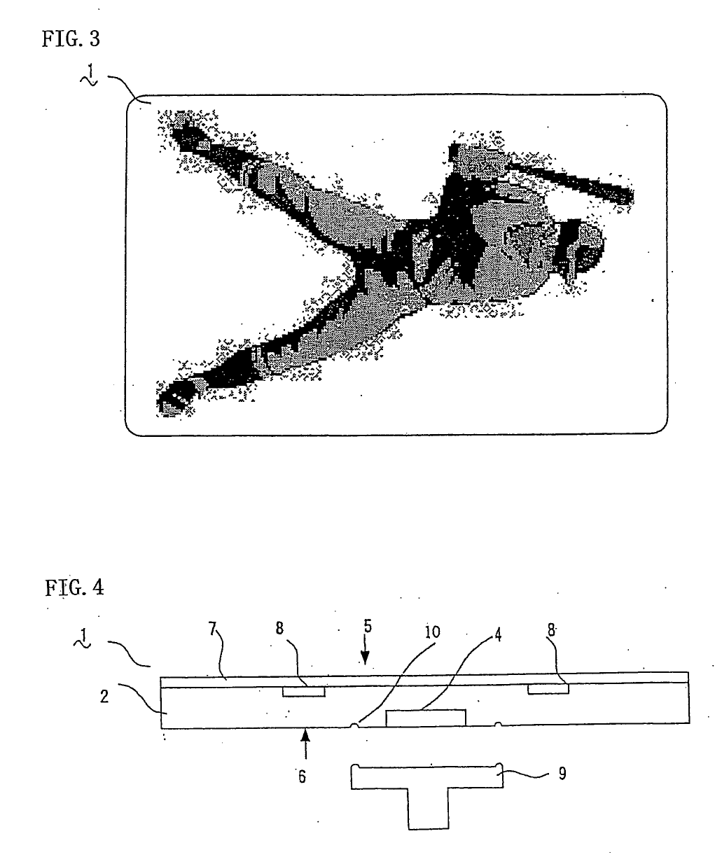

Referring to FIG. 1 to FIG. 3, an explanation will be given on an optical recording medium according to a first embodiment of the present invention. A sectional view of the inventive optical recording medium is shown in FIG. 1. Further, a rear view and a top view of the optical recording medium 1 as seen from a face 6 side and a face 5 side are shown in FIG. 2 and FIG. 3, respectively. Here, the medium 1 of the present invention is composed of a substrate 2 having a length of 90 mm and a width of 50 mm. In the one face 6 of the substrate 2, a circular recess 3 for engagement with a medium rotating device is formed almost in the center of the substrate. The circular recess 3 is formed in a cylindrical shape. Inside the substrate, a magnetic element 4 is provided around the circular recess and the recess fits with a protrusion of a chuck 9 of the disk rotating device so that the substrate is connected and fixed to the chuck by magnetic force. A storage area 8 for recording optical data thereon is formed in the other face 5, and a resin 7 for protecting the recorded data is applied to form a layer that covers the storage area. A design is printed on this resin coated face. The design printed face is entirely flat and has the design put on the entire surface thereof as shown in FIG. 3. Although the optical recording medium of a type having the magnetic element integrated therein is described in this embodiment, a metal piece may be integrated into the substrate and the magnetic element may be provided in the chuck 9.

The optical data recorded on the storage area 8 is read by applying laser light thereto such that the light is incident from the direction of the face 6.

Since the optical recording medium 1 of the present invention has no hole penetrating through the substrate 2, it allows a design to be put entirely on one face of the medium 1 including the center thereof, and thus, there can be combined an optical data recording function and a function that allows the medium to have a value in its design as does a trading card. Further, the magnetic force generated between the magnetic element 4 and the chuck 9 is used to chuck the medium 1, preventing the face 5 having a design put thereon from contacting a retaining plate or the like. Thus, damage to a design caused by chucking is prevented.

FIG. 4 is a view of an optical recording medium according to a second embodiment of the present invention. The same reference numerals are given to the same elements as those shown in the first embodiment. The second embodiment differs from the first embodiment in that a shallow annular recess 10 is formed in place of the cylindrical recess 3 and the disk-shaped magnetic element 4 is integrated in the center of the substrate 2. As described in the first embodiment, the substrate may include either the magnetic element or the metal piece, and preferably constructed to form a pair with the chuck 9. An annular protrusion that fits into the annular recess 10 is formed on the chuck 9. The rotation center is determined by bringing the protrusion into engagement with the annular recess 10. The optical recording medium 1 is fixed to the chuck by the magnetic force generated between the magnetic element 4 integrated in the substrate 2 and the chuck 9.

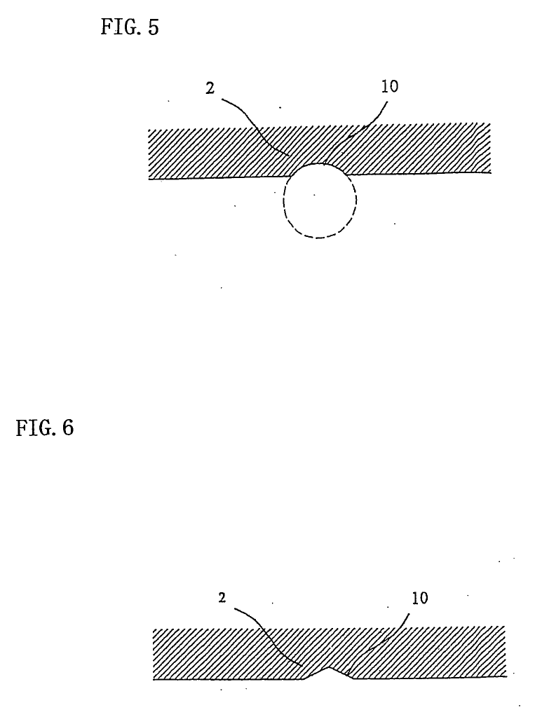

This constitution allows the face 6 to be flatter, which, when a number of optical recoding media are carried around, alleviate the problem of the outer edge of the medium 1 getting caught in the recess 10, and thereby improving the portability of the medium. The annular recess 10 preferably has an arc cross-section as shown in FIG. 5 or a triangle cross-section as shown in FIG. 6 such that each corner between the arc or triangle and the face 6 forms an obtuse angle when seen in cross section, making it easier to clean up the recess even when dirt is deposited therein.

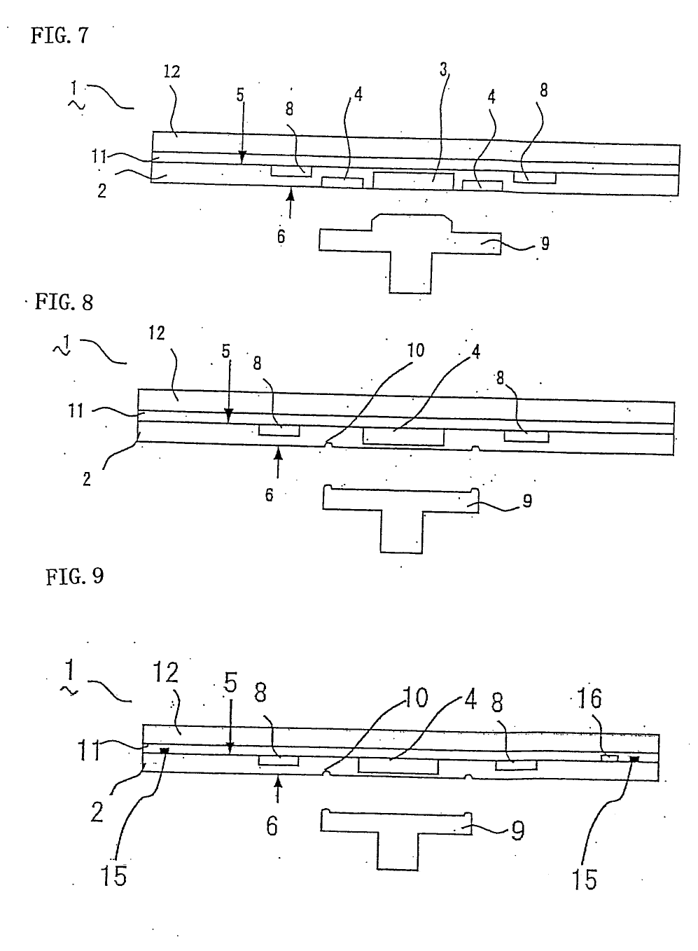

Referring to FIG. 7, an explanation will be given on an optical recording medium according to a third embodiment of the present invention. The same reference numerals are given to the same elements as those shown in the first and second embodiments. The third embodiment differs from the first embodiment in that, in the first embodiment a design is printed on the resin layer formed by the application of a resin on the plastic substrate, while in the third embodiment a cover layer 12 different from the resin layer is provided and the cover layer 12 is bonded via an adhesive 11 to a plastic substrate including a storage area 8 and a recess 3. In a method according to the first embodiment a design put on the optical recording medium is limited because the resin material applied to the substrate is limited, whereas in a method according to the third embodiment, a wider variety of designs can be printed because any material can be used for the cover layer 12.

The optical recording medium 1 of the third embodiment having the above constitution is advantageous in that the same effects as those of the medium 1 of the first embodiment can be expected, and further, the material for the cover layer 12 can be selected with prior consideration given to the quality of a design while in the first embodiment the material for the resin 7 needs to be selected with prior consideration given to the ease of application thereof and chemical effect on a data recording face. Therefore, the medium of the third embodiment can include an advanced design using metal foil or lenticular lens, for example.

FIG. 8 is a view of an optical recording medium according to a fourth embodiment of the present invention. This optical recording medium uses such a plastic substrate with a cover layer bonded thereto as that shown in the third embodiment and adopts the chucking system shown in the second embodiment. The same reference numerals are given to the same elements as those shown in the above embodiments.

With such a construction, the face 6 of the medium can be flatter, which, when a number of optical recoding media are carried around, alleviate the problem that the outer edge of the optical recording medium gets caught in the recess 10, and thereby improving the portability of the medium.

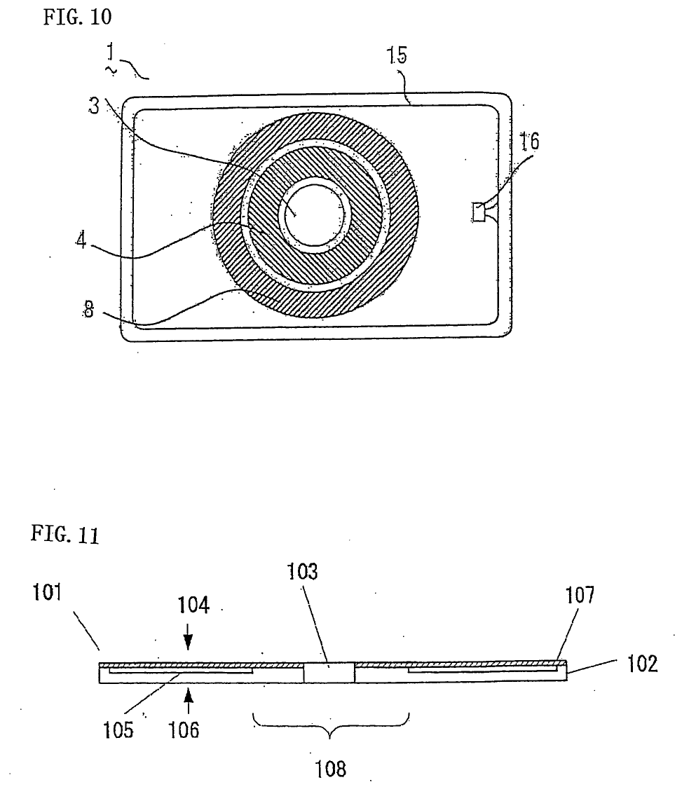

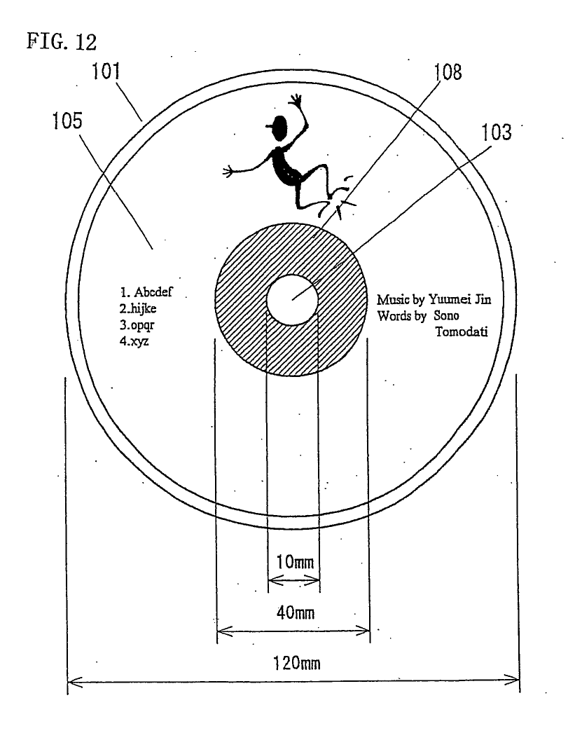

Referring to FIG. 9 and FIG. 10, an explanation will be given on an optical recording medium according to a fifth embodiment of the present invention. The same reference numerals are given to the same elements as those shown in the fourth embodiment. The fifth embodiment differs from the fourth embodiment in that it includes a memory 16 located on the adhesive layer 11 and a loop antenna 15 formed on a surface opposed to the cover layer 12 of the plastic substrate 2.

It is preferable that the memory 16 is a rewritable nonvolatile memory such as a flash memory. The memory 16 is connected to the antenna 15 and transmits data from/to the outside via the antenna 15. Further, the memory 16 can record and store data when necessary. Where the storage area 8 of the medium stores, for example, a game software therein, the memory can be used to record the progress of a game and a score of player(s) when the game has to be interrupted in progress so that the game can be continued from where it left off. Power necessary for driving the memory 16 is transmitted via the antenna 15 using radio waves of low frequency.

Since the memory 16 is rewritable, the number of interruption is not limited. Further, since it is nonvoltaic, long hours of interruption is not a problem.

Both power and data are transmitted via the antenna 15. This allows for transmission of data between the memory 16 and the outside even when the medium 1 is rotated for readout of the optical data stored in the storage area 8.

As described above, the optical recording medium of the present invention does not have a hole penetrating the substrate, whereby a design can be put entirely on one face of the medium including the center thereof. Thus, there can be combined an optical data recording function and a function that allows the medium to have a value in its design as does a trading card.

Further, by using the annular recess for chucking the medium, a flatter medium can be provided. This alleviates a disadvantage that the outer edge of the medium 1 gets caught in the recess 10, resulting in an improvement in portability of the medium.

Where the cover layer is used in the optical recording medium, there is an advantage that the material for the cover layer serving as a base for a design can be selected with prior consideration given to the quality of the design. Thus, a highly advanced design using, for example, metal foil can be put on the medium.

As a method for chucking the inventive optical recording medium, the magnetic force generated between the magnetic element or the metal piece integrated inside the substrate and the chuck is utilized to chuck the medium, whereby the face having a design put thereon does not touch a retaining plate or the like. This prevents the design from being damaged by chucking.

By making the annular recess to have an arc or triangle cross-section, the recess is easier to clean when dirt and the like are deposited therein.

Since the inventive optical recording medium includes the memory integrated therein and the memory can store the progress of a game or the like when it is interrupted, the game can be continued from where it is left off.

The memory is a nonvolatile semiconductor memory and it does not cause such a disadvantage as erasure of data during a long interruption.

Further, the antenna integrated inside the medium allows for noncontact readout of data stored in the memory, whereby transmission of data between the memory and the outside is possible even when the optical recording medium is rotated for readout of optical data.

1. An optical recording medium having data optically recorded thereon, characterized in that one face of a substrate of the optical recording medium has a circular recess formed therein for engagement with a rotating device for the optical recording medium, and the other face of the substrate has a flat surface with no projections and depressions, the flat face having a design put at least approximately on the center of the face.

2. An optical recording medium of claim 1, characterized in-that the circular recess is cylindrically formed approximately in the center of the optical recording medium.

3. An optical recording medium of claim 1, characterized in that the circular recess is annularly formed.

4. An optical recording medium of claim 3, characterized in that the annular recess has an arc or triangle cross-section, and each corner between the arc or triangle and the substrate face forms an obtuse angle when seen in cross section.

5. An optical recording medium of claim 1, characterized in that the substrate is composed of one plastic substrate, and the design put on the other face of the plastic substrate is formed by means of printing.

6. An optical recording medium of claim 1, characterized in that the substrate is composed of one plastic substrate and the other face of the plastic substrate has optical data recorded thereon, the other face being provided with an adhesive layer and a cover layer attached by the adhesive layer, the design being put on a surface of the cover layer.

7. An optical recording medium of claim 1, characterized in that the substrate has a metal piece or a magnetic element integrated therein.

8. An optical recording medium of claim 1, characterized in that the optical recording medium has a memory integrated therein.

9. An optical recording medium of claim 8, characterized in-that the memory is a nonvolatile semiconductor memory.

10. An optical recording medium of claim 8, characterized in that the optical recording medium has an antenna which is connected to the memory integrated therein.

11. An optical recording medium of claim 2, characterized in that the substrate is composed of one plastic substrate, and the design put on the other face of the plastic substrate is formed by means of printing.

12. An optical recording medium of claim 2, characterized in that the substrate is composed of one plastic substrate and the other face of the plastic substrate has optical data recorded thereon, the other face being provided with an adhesive layer and a cover layer attached by the adhesive layer, the design being put on a surface of the cover layer.

13. An optical recording medium of claim 2, characterized in that the substrate has a metal piece or a magnetic element integrated therein.

14. An optical recording medium of claim 2, characterized in that the optical recording medium has a memory integrated therein.

15. An optical recording medium of claim 3, characterized in that the substrate is composed of one plastic substrate, and the design put on the other face of the plastic substrate is formed by means of printing.

16. An optical recording medium of claim 3, characterized in that the substrate is composed of one plastic substrate and the other face of the plastic substrate has optical data recorded thereon, the other face being provided with an adhesive layer and a cover layer attached by the adhesive layer, the design being put on a surface of the cover layer.

17. An optical recording medium of claim 3, characterized in that the substrate has a metal piece or a magnetic element integrated therein.

18. An optical recording medium of claim 3, characterized in that the optical recording medium has a memory integrated therein.

19. An optical recording medium of claim 4, characterized in that the substrate is composed of one plastic substrate, and the design put on the other face of the plastic substrate is formed by means of printing.

20. An optical recording medium of claim 4, characterized in that the substrate is composed of one plastic substrate and the other face of the plastic substrate has optical data recorded thereon, the other face being provided with an adhesive layer and a cover layer attached by the adhesive layer, the design being put on a surface of the cover layer.

21. An optical recording medium of claim 4, characterized in that the substrate has a metal piece or a magnetic element integrated therein.

22. An optical recording medium of claim 4, characterized in that the optical recording medium has a memory integrated therein.

23. An optical recording medium of claim 5, characterized in that the substrate has a metal piece or a magnetic element integrated therein.

24. An optical recording medium of claim 5, characterized in that the optical recording medium has a memory integrated therein.

25. An optical recording medium of claim 6, characterized in that the substrate has a metal piece or a magnetic element integrated therein.

26. An optical recording medium of claim 6, characterized in that the optical recording medium has a memory integrated therein.

27. An optical recording medium of claim 7, characterized in that the optical recording medium has a memory integrated therein.
